(19) United States
(12) Patent Application Publication
(10) Pub. No.: US 2024/0418235 A1
(43) Pub. Date: Dec. 19, 2024

(54) Multi-Modal and Multi-Degree-Of-Freedom Piezoelectric Active Vibration Isolation Platform and Working Method Therefor

(71) Applicant: NANJING UNIVERSITY OF AERONAUTICS AND ASTRONAUTICS, Nanjing (CN)

(72) Inventors: Liang WANG, Nanjing (CN); Rui QI, Nanjing (CN); Ziyu SHEN, Nanjing (CN); Jiamei JIN, Nanjing (CN)

(73) Assignee: NANJING UNIVERSITY OF AERONAUTICS AND ASTRONAUTICS, Nanjing, CN (CN)

(21) Appl. No.: 18/747,394

(22) Filed: Jun. 18, 2024

(30) Foreign Application Priority Data
Jun. 19, 2023 (CN) 202310734102.5

(51) Int. Cl. F16F 15/00; B06B 1/06; F16M 11/22

(52) U.S. Cl. CPC F16F 15/007; B06B 1/0603; F16F 15/002; F16M 11/22; B06B 2201/30; F16F 2224/0283; F16F 2228/066; F16F 2230/18

(57) ABSTRACT

Disclosed is a multi-modal and multi-degree-of-freedom piezoelectric active vibration isolation platform and a working method therefor. The piezoelectric active vibration isolation platform includes an upper platform, a lower platform, a control module, and four vibration isolation modules, where the vibration isolation module includes a passive vibration isolation unit and an active vibration isolation unit; the passive vibration isolation unit includes an upper connector, a lower connector, a cross Hooke hinge, and a first acceleration sensor; the active vibration isolation unit includes a fixed beam, a pre-tightening bolt, a second acceleration sensor, and a driving component; the platform can provide active vibration isolation for the longitudinal (axial) vibration and the bending vibration in any radial direction of a vibration isolation object, and has the advantages of fast response, resistance to electromagnetic interference, and light weight.

### TECHNICAL FIELD

The present application relates to the field of piezoelectric driving and mechanical vibration control, and particularly relates to a multi-modal and multi-degree-of-freedom piezoelectric active vibration isolation platform and the working method therefor.

### BACKGROUND

Active vibration isolation platforms are widely used in the fields of aerospace, engineering machinery, mechanical transmission and the like, which can reduce the vibration amplitude of vibration isolation objects. Meanwhile, piezoelectric materials have the advantages of fast response, resistance to electromagnetic interference, high precision and light weight, and are suitable for the active vibration isolation platforms. However, due to the heavy weight, complex structure, slow response, high hysteresis, and difficulty in meeting vibration isolation for multi-degree-of-freedom vibration of the traditional active vibration isolation platforms, the traditional active vibration isolation platforms are limited in application, poor in vibration isolation effect, and not suitable for multi-degree-of-freedom vibration. Therefore, developing an active vibration isolation platform with light weight, compact structure and fast response has become an important research direction, and meeting the vibration isolation for the multi-degree-of-freedom vibration and multi-modal vibration has become a main problem to be solved urgently in this field.

### SUMMARY OF THE INVENTION

A technical problem to be solved by the present application is to provide a spacecraft vibration suppression structure and method based on piezoelectric composite materials in view of defects involved in the background.

To solve the above technical problems, the present application adopts the technical solution as follows:
A multi-modal and multi-degree-of-freedom piezoelectric active vibration isolation platform includes an upper platform, a lower platform, first to fourth vibration isolation modules, and a control module, wherein
the first to fourth vibration isolation modules have the same structure, and each includes a passive vibration isolation unit and an active vibration isolation unit;
the passive vibration isolation unit includes an upper connector, a lower connector, a cross Hooke hinge, and a first acceleration sensor, where the upper connector and the lower connector are regular quadrangular prisms with the same cross-sectional shape, each includes first to fourth side walls perpendicularly and fixedly connected end to end in sequence; two ends of the cross Hooke hinge are separately connected with a lower end face of the first acceleration sensor and an upper end face of the lower connector, so that the first to fourth side walls of the upper connector and the lower connector are coplanar one by one, and two rotating shafts of the cross Hooke hinge are separately perpendicular to the first side wall and the second side wall of the upper connector; a threaded blind hole is provided in the center of a lower end face of the lower connector; the first acceleration sensor is arranged on an end face of the upper connector, connected in series with the upper connector and the upper platform, and configured to sense a vibration signal of the upper platform;
The active vibration isolation unit includes a fixed beam, a pre-tightening bolt, a second acceleration sensor, and a driving component; the fixed beam and the lower connector are regular quadrangular prisms with the same cross-sectional shape, and a countersunk through hole through which the pre-tightening bolt penetrates is provided in the center of a lower end face of the fixed beam; the driving component includes 2N piezoelectric ceramic plates, and N is a natural number greater than or equal to 1; the shape of the piezoelectric ceramic plate is the same as the cross-sectional shape of the lower connector, and a through hole through which the pre-tightening bolt penetrates is provided in the center of the piezoelectric ceramic plate; the pre-tightening bolt sequentially penetrates through the fixed beam and the 2N piezoelectric ceramic plates and is then in threaded connection with the threaded blind hole on the lower end face of the lower connector, to tightly clamp the 2N piezoelectric ceramic plates between the fixed beam and the lower connector; the 2N piezoelectric ceramic plates are polarized along a thickness direction thereof, and polarization directions of the adjacent piezoelectric ceramic plates are opposite; the second acceleration sensor is arranged in an inner hole of the fixed beam, and configured to sense a vibration signal of the fixed beam;
The upper platform and the lower platform are both square flat plates, the upper platform is configured to be fixedly connected with a vibration isolation object, and the lower platform is configured to be fixedly connected with a vibration source needing to be fixed to the vibration isolation object.

An array of the first to fourth vibration isolation modules is between the upper platform and the lower platform, upper end faces of the upper connectors of the first to fourth vibration isolation modules are all fixedly connected with the upper platform, and the lower end faces of the fixed beams are all fixedly connected with the lower platform, so that the first side walls of the upper connectors in the first and second vibration isolation modules are coplanar, the first side walls of the upper connectors in the third and fourth vibration isolation modules are coplanar, and the first side walls of the upper connectors in the first and third vibration isolation modules are parallel;
The upper platform involved in an embodiment of the present application is further provided with a plurality of bolt holes configured to be connected with the vibration isolation object.

At least one embodiment of the present application further discloses a working method using the multi-modal and multi-degree-of-freedom piezoelectric active vibration isolation platform, including the following steps in the detail description section.

Compared with the prior art, the technical solution disclosed by the embodiments of the present application has the following technical effects:
1. The piezoelectric active vibration isolation platform disclosed by the embodiments of the present application adopts a sandwich piezoelectric transducer configuration, and has the advantages of compact structure, high performance, rapid system response, resistance to electromagnetic interference and high active vibration isolation effect.
2. The piezoelectric active vibration isolation platform disclosed by the embodiments of the present application adopts piezoelectric materials, meets the multi-modal active vibration isolation for a longitudinal vibration modality and a bending vibration modality, and meanwhile can effectively isolate the multi-degree-of-freedom vibration of axial longitudinal vibration and bending vibration in any axial direction.

### BRIEF DESCRIPTION OF FIGURES

FIG. 1 is a schematic structural diagram of a piezoelectric active vibration isolation platform in an embodiment;

FIG. 2 is a schematic structural diagram of a passive vibration isolation unit of a piezoelectric active vibration isolation platform in an embodiment;

FIG. 3 is a schematic structural diagram of a driving component in an active vibration isolation unit of a piezoelectric active vibration isolation platform in an embodiment;

FIG. 4 is a structural cutaway view of a piezoelectric active vibration isolation platform in an embodiment;

FIG. 5 is the schematic diagrams of the deformation comparison of an active vibration isolation working modality of a piezoelectric active vibration isolation platform for longitudinal vibration in an embodiment;

FIG. 6 is the schematic diagrams of a principle of a piezoelectric active vibration isolation platform in an embodiment, where A-C are schematic diagrams of comparison of the piezoelectric active vibration isolation platform without disturbance, without active vibration isolation for longitudinal vibration and with active vibration isolation for longitudinal vibration separately.

FIG. 7 is the schematic diagrams of deformation comparison of an active vibration isolation working modality of a piezoelectric active vibration isolation platform for bending vibration in four typical directions;

FIG. 8 is the schematic diagrams of vibration isolation of a piezoelectric active vibration isolation platform in an embodiment, where A-C are schematic diagrams of comparison of the piezoelectric active vibration isolation platform without disturbance, without active vibration isolation for bending vibration and with active vibration isolation for bending vibration separately; and

In the figures, 1—upper platform, 2—third vibration isolation module, 3—lower platform.

### DETAILED DESCRIPTION

The technical solution of the present application will be further described in detail below in combination with the accompanying drawings:

The technical solution of the present application can be implemented in many different forms and should not be considered as limited to the embodiments described herein. Instead, these embodiments are provided to make the present application thorough and complete, and will adequately express the scope of the present application to those skilled in the art. In the drawings, components are enlarged for clarity.

### Embodiment 1

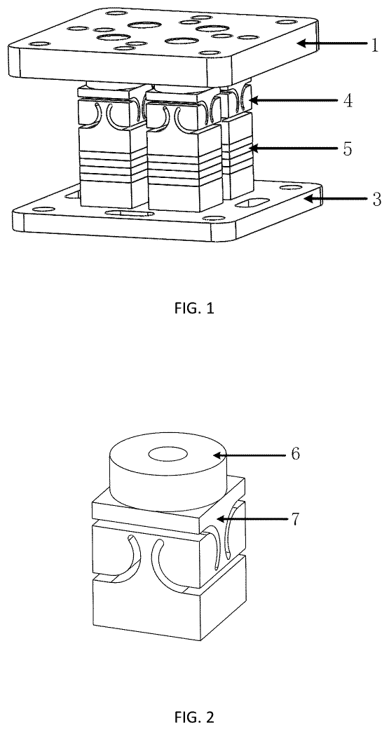

As shown in FIG. 1, this embodiment relates to a multi-modal and multi-degree-of-freedom piezoelectric active vibration isolation platform, including an upper platform, a lower platform, first to fourth vibration isolation modules, and a control module. The above first to fourth vibration isolation modules have the same structure, and each includes a passive vibration isolation unit and an active vibration isolation unit.

As shown in FIG. 2, the passive vibration isolation unit includes an upper connector, a lower connector, a cross Hooke hinge, and a first acceleration sensor, where the upper connector and the lower connector are regular quadrangular prisms with the same cross-sectional shape, each includes first to fourth side walls perpendicularly and fixedly connected end to end in sequence; two ends of the cross Hooke hinge are connected with a lower end face of the first acceleration sensor and an upper end face of the lower connector separately, so that the first to fourth side walls of the upper connector and the lower connector are coplanar one by one, and two rotating shafts of the cross Hooke hinge are perpendicular to the first side wall and the second side wall of the upper connector separately; a threaded blind hole is provided in the center of a lower end face of the lower connector; the first acceleration sensor is arranged on an end face of the upper connector, connected in series with the upper connector and the upper platform, and configured to sense a vibration signal of the upper platform.

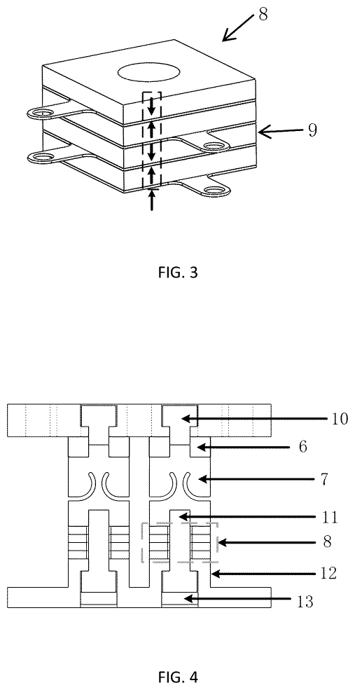

The active vibration isolation unit includes a fixed beam, a pre-tightening bolt, a second acceleration sensor, and a driving component; the fixed beam and the lower connector are regular quadrangular prisms with the same cross-sectional shape, and a countersunk through hole through which the pre-tightening bolt penetrates is provided in the center of a lower end face of the fixed beam; as shown in FIG. 3, the driving component includes 2N piezoelectric ceramic plates, and N is a natural number greater than or equal to 1; the shape of the piezoelectric ceramic plate is the same as the cross-sectional shape of the lower connector, and a through hole through which the pre-tightening bolt penetrates is provided in the center of the piezoelectric ceramic plate; the pre-tightening bolt sequentially penetrates through the fixed beam and the 2N piezoelectric ceramic plates and is then in threaded connection with the threaded blind hole on the lower end face of the lower connector, to tightly clamp the 2N piezoelectric ceramic plates between the fixed beam and the lower connector; the 2N piezoelectric ceramic plates are polarized along a thickness direction thereof, and polarization directions of the adjacent piezoelectric ceramic plates are opposite; the second acceleration sensor is arranged in an inner hole of the fixed beam, and configured to sense a vibration signal of the fixed beam.

The upper platform and the lower platform are both square flat plates, the upper platform is configured to be fixedly connected with a vibration isolation object, and the lower platform is configured to be fixedly connected with a vibration source needing to be fixed to the vibration isolation object.

An array of the first to fourth vibration isolation modules is between the upper platform and the lower platform, upper end faces of the upper connectors of the first to fourth vibration isolation modules are all fixedly connected with the upper platform, and the lower end faces of the fixed beams are all fixedly connected with the lower platform, so that the first side walls of the upper connectors in the first and second vibration isolation modules are coplanar, the first side walls of the upper connectors in the third and fourth vibration isolation modules are coplanar, and the first side walls of the upper connectors in the first and third vibration isolation modules are parallel.

The control module is electrically connected with the first acceleration sensors, the second acceleration sensors, and the driving components in the first to fourth vibration isolation modules separately, and is configured to control the driving components in the first to fourth vibration isolation modules to work according to sensed data of the first acceleration sensors and the second acceleration sensors in the first to fourth vibration isolation modules.

As shown in FIG. 4, the upper platform is provided with a plurality of bolt holes configured to be connected with the vibration isolation object.

The acceleration sensors in the first to fourth vibration isolation modules generate vibration signals corresponding to disturbance of the vibration source, and the vibration signals have the same frequency and phase as vibration at a location of the vibration isolation module, and have the amplitude positively correlated with the intensity of the vibration at the location of the vibration isolation module. If the vibration signals generated by the acceleration sensors in the first to fourth vibration isolation modules have the equal amplitude, it means that the vibration isolation object is in a longitudinal vibration modality. If two of the vibration signals generated by the acceleration sensors in the first to the fourth vibration isolation modules have a phase difference of 180 degrees, it means that the vibration isolation object is in a bending vibration modality.

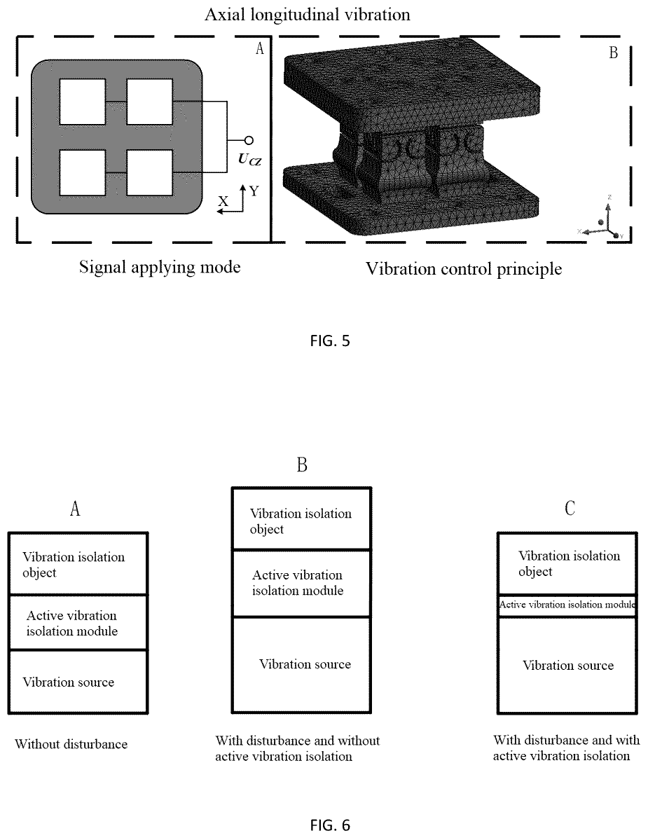

FIG. 5 is a schematic diagram for longitudinal vibration. In FIG. 5. Ucz is used for indicating that electric signals applied to the four active vibration isolation modules are the same, A is a signal applying mode and B is a vibration deformation diagram, that is, a vibration mode diagram. A principle of active vibration isolation is to introduce secondary vibration through the vibration isolation platform, and the secondary vibration and vibration of the vibration source maintain opposite phases, consistent frequency, and the equal amplitude, that is, the secondary vibration and the vibration of the vibration source cancel each other.

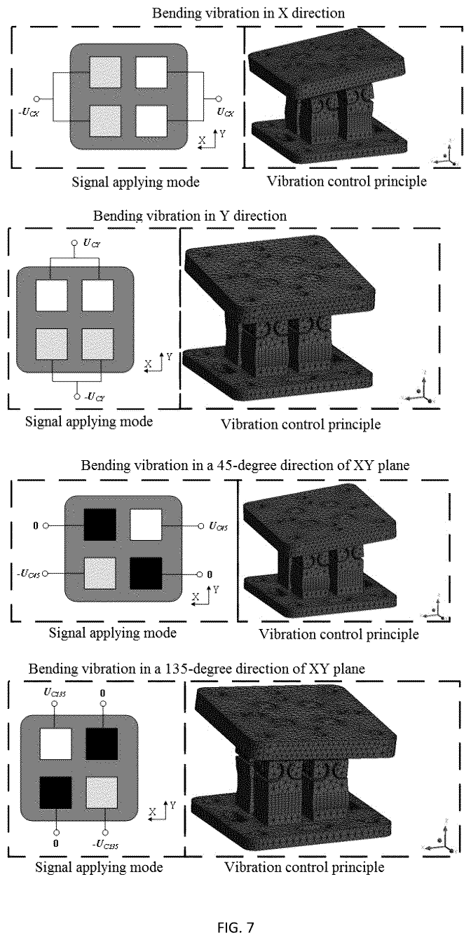

For bending vibration, the principle of active vibration isolation is that bending deformation generated in the present application can achieve a vibration isolation effect. The piezoelectric active vibration isolation platform can generate bending vibration in any radial direction, and a vibration mode diagram of bending vibration of the piezoelectric active vibration isolation platform is shown in FIG. 7, the typical directions are X direction, Y direction, a 45-degree axis direction of XY plane and a 135-degree axis direction of XY plane separately.

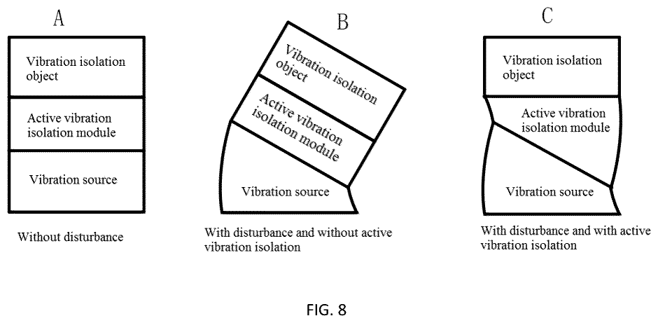

Bending deformation generated by the vibration isolation platform provided in this embodiment and deformation of the vibration source cancel each other, the vibration isolation effect is achieved through a vibration amplitude isolation principle, and a schematic diagram of the deformation of the vibration isolation platform is shown in FIG. 8.

Specific working steps of the above piezoelectric active vibration isolation platform are as follows:

Finally, the active vibration isolation unit in the vibration isolation module generates secondary vibration with the same frequency and amplitude, and the opposite phase as vibration at the location to cancel the vibration of the vibration source.

It can be understood by those skilled in the art that unless otherwise defined, all terms (including technical terms and scientific terms) used herein have the same meaning as commonly understood by those skilled in the art of the present application. It should also be understood that terms such as those defined in general dictionaries should be understood to have meanings consistent with those in the context of the prior art, and unless defined as here, will not be interpreted with idealized or overly formal meanings.

The specific implementations mentioned above further explain the objective, technical solutions, and beneficial effects of the present application in detail. It should be understood that the above embodiments are only specific implementations of the present application, and are not intended to limit the present application. Any modifications, equivalent replacements, improvements, etc. made within the spirit and principles of the present application should be included in the scope of the present application.

1. A multi-modal and multi-degree-of-freedom piezoelectric active vibration isolation platform, comprising an upper platform, a lower platform, first to fourth vibration isolation modules, and a control module, wherein
the first to fourth vibration isolation modules have a same structure, and each comprises a passive vibration isolation unit and an active vibration isolation unit;
the passive vibration isolation unit comprises an upper connector, a lower connector, a cross Hooke hinge, and a first acceleration sensor, wherein the upper connector and the lower connector are regular quadrangular prisms with the same cross-sectional shape, each comprises first to fourth side walls perpendicularly and fixedly connected end to end in sequence; two ends of the cross Hooke hinge are separately connected with a lower end face of the first acceleration sensor and an upper end face of the lower connector, so that the first to fourth side walls of the upper connector and the lower connector are coplanar one by one, and two rotating shafts of the cross Hooke hinge are separately perpendicular to the first side wall and the second side wall of the upper connector; a threaded blind hole is provided in the center of a lower end face of the lower connector; the first acceleration sensor is arranged on an end face of the upper connector, connected in series with the upper connector and the upper platform, and configured to sense a vibration signal of the upper platform;
the active vibration isolation unit comprises a fixed beam, a pre-tightening bolt, a second acceleration sensor, and a driving component; the fixed beam and the lower connector are regular quadrangular prisms with the same cross-sectional shape, and a countersunk through hole through which the pre-tightening bolt penetrates is provided in the center of a lower end face of the fixed beam; the driving component comprises 2N piezoelectric ceramic plates, and N is a natural number greater than or equal to 1; the shape of the piezoelectric ceramic plate is the same as the cross-sectional shape of the lower connector, and a through hole through which the pre-tightening bolt penetrates is provided in the center of the piezoelectric ceramic plate; the pre-tightening bolt sequentially penetrates through the fixed beam and the 2N piezoelectric ceramic plates, and is then in threaded connection with the threaded blind hole on the lower end face of the lower connector, to tightly clamp the 2N piezoelectric ceramic plates between the fixed beam and the lower connector; the 2N piezoelectric ceramic plates are polarized along a thickness direction thereof, and polarization directions of the adjacent piezoelectric ceramic plates are opposite; the second acceleration sensor is arranged in an inner hole of the fixed beam, and configured to sense a vibration signal of the fixed beam;
the upper platform and the lower platform are both square flat plates, the upper platform is configured to be fixedly connected with a vibration isolation object, and the lower platform is configured to be fixedly connected with a vibration source needing to be fixed to the vibration isolation object;
an array of the first to fourth vibration isolation modules is between the upper platform and the lower platform, upper end faces of the upper connectors of the first to fourth vibration isolation modules are all fixedly connected with the upper platform, and the lower end faces of the fixed beams are all fixedly connected with the lower platform, so that the first side walls of the upper connectors in the first and second vibration isolation modules are coplanar, the first side walls of the upper connectors in the third and fourth vibration isolation modules are coplanar, and the first side walls of the upper connectors in the first and third vibration isolation modules are parallel; and
the control module is electrically connected with the first acceleration sensors, the second acceleration sensors, and the driving components in the first to fourth vibration isolation modules separately, and is configured to control the driving components in the first to fourth vibration isolation modules to work according to sensed data of the first acceleration sensors and the second acceleration sensors in the first to fourth vibration isolation modules.

2. The multi-modal and multi-degree-of-freedom piezoelectric active vibration isolation platform according to claim 1, wherein the upper platform is provided with a plurality of bolt holes configured to be connected with the vibration isolation object.

3. A working method of the multi-modal and multi-degree-of-freedom piezoelectric active vibration isolation platform according to claim 1, comprising the following steps:
for each vibration isolation module of the first to fourth vibration isolation modules:
step 1), collecting, by the control module, a vibration signal A generated by the second acceleration sensor in the vibration isolation module;
step 2), filtering, by the control module, the vibration signal A to stabilize the same, then adjusting a filtered vibration signal, to make the phase of the filtered vibration signal opposite to the original phase, and obtaining a vibration isolation signal B;
step 3), using, by the control module, the vibration isolation signal B as a driving signal for the driving component of the active vibration isolation unit in the vibration isolation module, and driving the active vibration isolation unit of the vibration isolation module to work through the driving signal; and
step 4), collecting, by the control module, a vibration signal C generated by the first acceleration sensor in the vibration isolation module, determining whether the amplitude of the vibration signal C is greater than or equal to a preset maximum amplitude threshold, and in a case that the amplitude of the vibration signal C is greater than or equal to the preset maximum amplitude threshold, amplifying, by the control module, the vibration isolation signal B, so that the amplitude of the vibration isolation signal B is equal to the original amplitude plus a preset step amplitude threshold, and then skipping performing step 3).
